(19) United States
(12) Patent Application Publication
(10) Pub. No.: US 2016/0241080 A1
(43) Pub. Date: Aug. 18, 2016

(54) All Electric In-House 5.K.W.Series Portable Generator

(71) Applicant: nathaniel smith, parkin, AR (US)

(72) Inventor: nathaniel smith, parkin, AR (US)

(21) Appl. No.: 13/705,961

(22) Filed: Dec. 5, 2012

(51) Int. Cl. H02J 9/04

(52) U.S. Cl. CPC H02J 9/04

(57) ABSTRACT

A all electric in-house 5 .k.w. series portable generator having a self-reliance battery pack, assembly to a power integrator attached to a frame member, which make a conversion of direct (dc) current into alternate (ac) current providing electricity to home, and apartment doing a power outage.

This present invention relates in general to a all electric in-house self-reliance generator, portable generator electricity for homes doing a power outages. Its environmentally friendly to be able to used and stored its' indoors give it an advantage over devices in the prior art. This all electric generator is powered by an self-reliance battery pack assembly to a power integrator that converted direct (dc) current into alternate current (ac) by electro mechanical, its noises free, light weight, having a cab light to enable an operator to see doing operational period. Its virtual maintenance free and start to produce electricity at the push of a button when a power outage occur.

### BRIEF DESCRIPTION OF THE DRAWINGS

FIG. 1: A front elevational view of present invention

FIG. 2: Is a rear elevational of the present invention

FIG. 3: Is a left side view of present invention

FIG. 4: Is a right side view of present invention

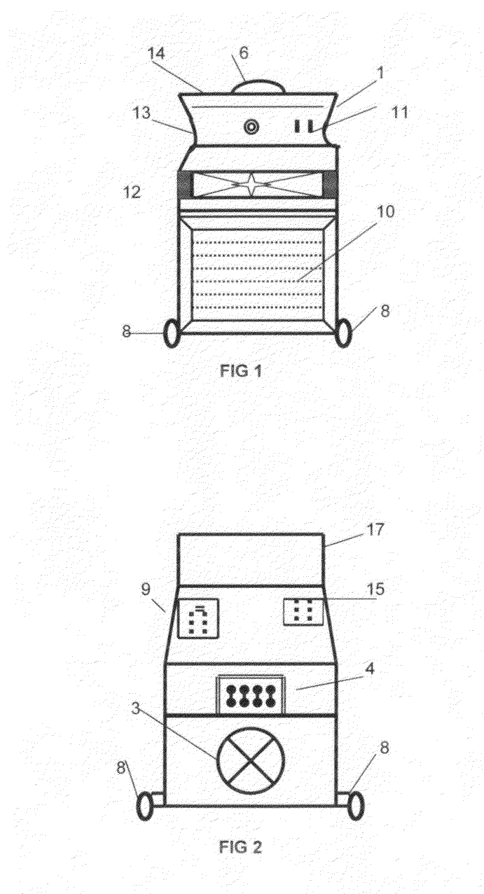

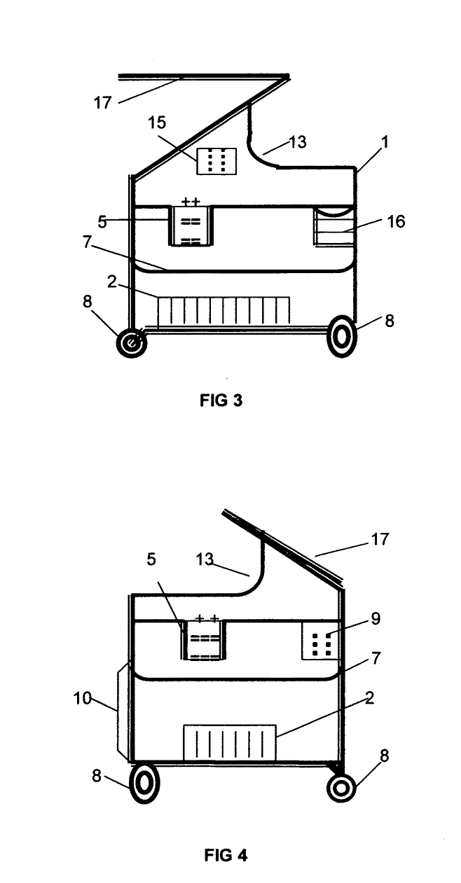

### DETAIL DESCRIPTION

Referring to the drawing in detail description therein element are indicated by numerates showing embodiments of a all electric in-house 5 k. w. series portable generator 1 a steel generator frame cover with aluminum panels 5 having 36 volts self-reliance battery pack mounted to center support beam. 2 a power integrator enclosed in aluminum housing mounted to generator bottom frame.

A power integrator enclosed in a aluminum housing connecting 5 36 volts self-reliance battery-pack 11 push on-off switch, 9 main power lug, 4 receptacle outlet, 15 circuit panel, 3 exhaust fans mounted therein rear panel connecting 15 circuit panel, which come on automatically when the cabinet temperature reached 65′ 10 front vent mount there-in generator bottom frame 1 enabled 3 exhaust fans to pull fresh air through the generator cabinet.

4 four receptacle outlet mounted therein the enter of the generator top rear frame connected 15 circuit panel with individual, 15 amp circuit breaker there in 9 main power lug 5 36 volt self-reliance battery pack supplying 2 power integrator with continuous direct (dc) current. 6 oval shape ring attach the top center of 1 generator main frame to enable a user to hook or tie cable into and load or unload.

7 oblong handles on each side of generator center exterior panel to 1 main frame center support beams to make mobility easy for users 8 four wheels attached to generator bottom 1 main frame the two rear wheels being swivels and lock. The two front wheels roll straight giving a users guiding mobility 9 main power lug having six circuit breakers therein connecting 2 power integrator and 15 circuit breaker panel in a wiring configuration.

10 a front vent covering the bottom half of generator front mounted to the side and bottom main frame allowing 3 exhaust fans to pull fresh air through 10 front vent keeping inside cabin elements at 65′ 11 a push on/off switch mounted therein the right side of 11 control panel connecting 2 power integrator turn the generator and 12 front cab light on/off.

12 a receptacles-shape cab light mounted therein 1 generator top front frame right above 10 front air vent connecting 15/11 in a wiring configuration which come on with 1 generator light up the front are around the generator, enable a user to see how to connected load doing a power outage.

13 control panel mounted under 1 generator extended top protecting 11 push on/off switch and 14 indicating light from the weather 15 circuit breaker panel mounted to 1 generator main frame under 17 hatch-back-top in back of 13 control panel 17 hatch-top open upward for 4 receptacles outlet and lock down therein allowing easy access to 15 circuit breakers panel to wiring and fuses replacement.

14 green indicating light mounted therein left side of 13 control panel connecting 11 push on/off switch and 15 circuit breaker panel which come on with 1 generator and stay on while generator is operating. It served as an indication the generator is on, 15 circuit breaker panels is a wiring configuration junction connecting 9 circuit breaker panels

15 circuit breaker panels mounted to 1 main frame under hatch back top where a wiring configuration take placed, connecting 9 main power lug supply 15 with 120 volts of AC current to 15 circuit breakers panel 16 120 volts external disconnect mounted therein 1 generator left lower corner which can be connected direct to loads 17 hatch back top mounted at the top of 1 main frame closed and lock down at 4 receptacles outlet, it can also be prop open giving access to 15 circuit breaker panel.

1. a all electric in-house 5 .k.w. series portable generator include a self-reliance battery pack connected to an dc and ac circuit panel, include a 40 amps fuses, a powers integrator enclosed in a aluminum body, and a front cab light, including a control panel, a front grill-vent, an exhaust fan in the rear panel, a green indicating light in the front control panel, four wheels two in the rear being swivels and two in front roll straight. This all electric in-house 5 .k.w. series portable generator have a 6-circuit main lug mounted on the right upper left corner, including a 240 volts disconnect mounted to cab exterior for direct load hook-up.

2-17) (canceled)
